(19) United States
(12) Patent Application Publication
(10) Pub. No.: US 2010/0190055 A1
(43) Pub. Date: Jul. 29, 2010

(54) BATTERY CELL CONNECTION METHOD AND APPARATUS

(75) Inventor: Alexander D. Khakhalev, Troy, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/361,580

(22) Filed: Jan. 29, 2009

(51) Int. Cl. H01M 4/02; B23K 28/00; B23K 20/10

(52) U.S. Cl. 429/211; 228/101; 228/110.1

(57) ABSTRACT

A battery module includes an electrochemical battery cell having a pair of cell tabs and conductive interconnecting members having one or more interconnect extensions. The cell tabs are welded to different interconnecting members to form welded joints, and each interconnect extension is hemmed with respect to the cell tabs to overlap and reinforce the welded joint. The welded joint can be ultrasonically-welded, while the interconnecting member can have a generally U-shaped profile with side walls formed integrally with the interconnect extensions. A method of minimizing effects of a shearing stress in the battery module includes fusing a cell tab or tabs to the interconnecting member to form a welded joint, and then hemming an interconnect extension of the interconnecting member to form a hem seam overlapping the cell tabs. Fusing can include ultrasonically welding the cell tabs to the side walls or other suitable means.

### TECHNICAL FIELD

The invention relates to electrochemical cell stack-type battery modules, and in particular to battery cell stacks or modules having welded cell tab connections, and to a method of forming the same.

### BACKGROUND OF THE INVENTION

Multi-cell electrochemical devices, also referred to as battery cell stacks or multi-cell battery modules, can be used for a variety of different applications, including the powering of various electronic devices, for vehicle propulsion, etc. While conventional battery designs such as alkaline, voltaic pile, and lead-acid batteries have been used in countless household and industrial applications for the past few centuries, evolving battery types such as nickel cadmium (NiCd), nickel-metal hydride (Ni-MH), lithium ion, and lithium ion polymer batteries have displayed particular utility in emerging electric and hybrid gas/electric vehicle propulsion applications, due in large part to their superior energy densities. Such batteries are often selectively rechargeable either as plug-in style batteries or onboard during a regenerative braking event, depending on the particular configuration of the vehicle.

In certain modern polymeric cell batteries, an electrode and separator sheets of adjacent cells can be laminated onto each other in order to form the battery cell without requiring a rigid and heavy outer metal battery casing that is commonplace in a typical 12-volt (V) lead acid battery or in conventional household batteries. The lack of a rigid outer casing also allows for innovative cell stacking or other cell configurations, whether aboard a vehicle or within other non-vehicular applications. For example, battery cells can be positioned adjacently to each other, and their conductive terminals or cell tabs welded together in a particular manner suitable for completing the electrical circuit. The long term reliability and effectiveness of a multi-cell battery thus depends to a large extent on the integrity of the welded electrical interconnections between the various cells forming the multi-cell battery.

### SUMMARY OF THE INVENTION

Accordingly, a battery module is provided having an optimized electrical connection between the respective positive and negative terminal portions or cell tabs of each electrochemical cell and a conductive rail or interconnecting member. Each cell tab is welded or fused to a surface of a different interconnecting member to thereby form a pair of welded joints. When the welded joints are used aboard a hybrid or electric vehicle, the welded joints can degrade over time due to various factors that can occur during common vehicular applications.

For example, a welded joint might be subjected to vibration and/or shearing stresses due to motion of the vehicle. Likewise, a welded joint can be weakened due to natural electrolytic corrosion, and/or corrosion due to exposure to potentially aggressive chemical vapors and/or aerosols. Over time, the initial quality of a welded joint can degrade to some extent, a condition that can potentially lead to a reduced level of electrical conductivity at or along the welded joint, with a resultant decrease in output voltage of the battery module.

Therefore, in accordance with the invention the interconnecting member of a cell stack or battery module is configured with a plurality of tabs or interconnect extensions. After the cell tabs have been welded or otherwise fused to the interconnecting member, the interconnect extensions are bent, folded, or otherwise hemmed around the locus of or in proximity to the welded joint. The resultant hem seam serves as a physical support to the welded joint, thus reinforcing the electrical connection of the cell tabs of the various battery cells. That is, the hem seam secures the cell tabs of the battery cells to the interconnecting member in an additional way, such that a failure of any portion of the welded joint does not necessarily result in a decreased level of electrical conductivity at or along the welded joint.

In particular, a battery module is provided having a plurality of electrochemical cells each having a pair of cell tabs, i.e., a positive tab and a negative tab, and a conductive interconnecting member having a plurality of interconnect extensions. The cell tabs of two or more adjacent battery cells can be welded or fused together, and also fused to a surface of the conductive interconnecting member to thereby form a welded joint. Additionally, the interconnect extensions can be bent, folded, or otherwise hemmed with respect to the cell tabs near the welded joint to thereby at least partially overlap with the cell tabs, and thus reinforce the welded joint.

A welded joint, which according to an exemplary embodiment can be ultrasonically-welded, is formed with respect to a surface of one or both of a pair of lateral side walls of the conductive interconnecting member, which include a base extending between the pair of lateral side walls to thereby define a generally U-shaped profile. Each of the side walls can be formed integrally with a pair of interconnect extensions. While the conductive interconnecting member can be constructed of any suitable conductive material, according to one embodiment the conductive interconnecting member is constructed essentially of copper.

A method of minimizing shearing stresses in a multi-cell battery module includes fusing, e.g., ultrasonically welding or otherwise joining, a cell tab of each of a plurality of electrochemical cells to a surface of an elongated connecting member to thereby form a welded joint, and then hemming a portion of the connecting member, such as one or more interconnect extensions, around or over the cell tab to thereby form a hem seam. The hem seam can at least partially overlap the welded joint, additionally minimizing the effects of a shearing stress in the welded joint.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a perspective side view of an elongated interconnecting member that is usable within a cell stack or battery module in accordance with the invention;

FIG. 2 is a schematic plan view of an exemplary electrochemical battery cell having a pair of terminals or cell tabs;

FIG. 3A is a schematic partial cutaway end view of a portion of the cell stack or battery module of the invention;

FIG. 3B is a perspective view of the interconnecting member and cells tabs having a welded and hemmed connection;

FIG. 4 is a graphical flow chart describing a method of forming or manufacturing the battery module of FIG. 3A; and

FIG. 5 is a plan view of an exemplary cell stack or battery module in accordance with the invention.

### DESCRIPTION OF THE PREFERRED EMBODIMENTS

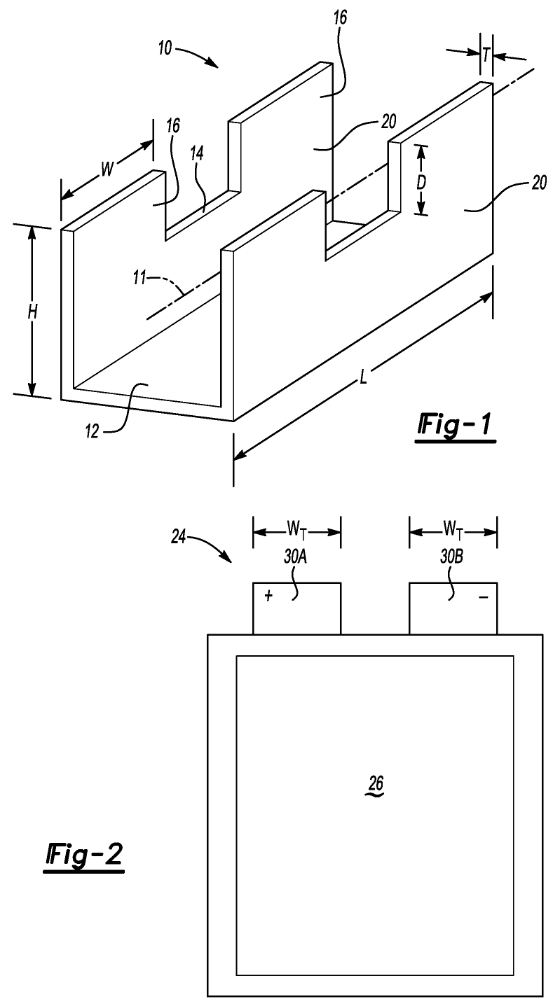

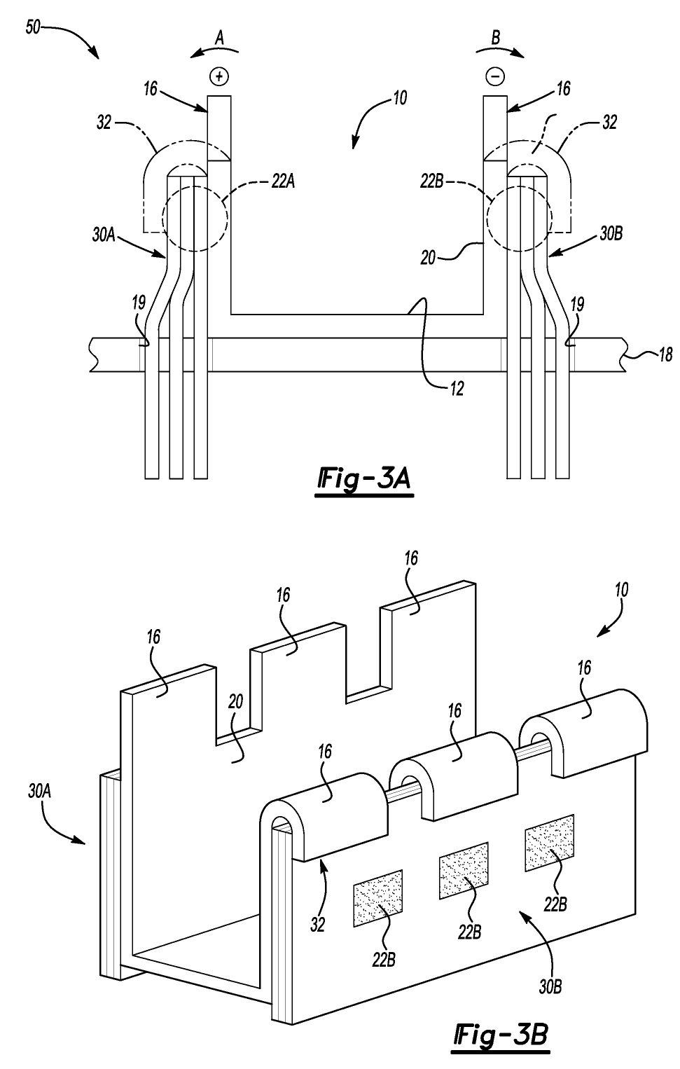

Referring to the drawings, wherein like reference numbers refer to like components, and beginning with FIG. 1, an elongated interconnecting member 10 is configured for use within a cell stack or battery module 50, as described below with reference to FIG. 3A and 5. By way of example, the battery module 50 could be sufficiently sized to provide the necessary voltage for powering an electric vehicle or a hybrid gasoline/electric vehicle, e.g., approximately 300 to 400 volts or more, depending on the required application. The interconnecting member 10 is constructed of a suitable conductive material, for example pure or elemental copper in one embodiment, or at least approximately 90% copper if an alloy of elemental copper is used, although other conductive embodiments can be envisioned without departing from the intended scope of the invention.

The interconnecting member 10 is shaped, sized, and/or otherwise configured to form an elongated rail or bus bar. According to one exemplary embodiment, the interconnecting member 10 can include a pair of parallel side walls 20 each operatively connected to or formed integrally with a base 12 to define a generally U-shaped profile. The base 12 can be mounted to an interconnect board 18 of the battery module 50 as shown in FIG. 3A and described below.

As shown in the embodiment of FIG. 1, the interconnecting member 10 has an axis or centerline 11, an axial length (L), a height (H), and a wall thickness (T), each of which can be selected or modified depending on the particular application. Each of the parallel side walls 20 defines at least one notch 14 of a depth (D), with the notches 14 forming or defining a plurality of tabs or interconnect extensions 16 each having a width (W). That is, the size and number of the notches 14 formed or provided in each of the side walls 20 will ultimately determine the size of each of the interconnect extensions 16. While each interconnect extension 16 is generally rectangular in shape, other shapes can also be provided within the scope of the invention by shaping the interconnecting member 10 as desired. The number of interconnect extensions 16 can vary within the scope of the invention as described below with reference to FIG. 3A.

Referring to FIG. 2, an exemplary battery cell 24 can be embodied as any of a number of different designs, e.g., lithium ion, lithium ion polymer, nickel metal hydride, nickel cadmium, etc., depending upon the intended application. The battery cell 24 includes a positively-charged terminal or cell tab 30A, which in one embodiment is constructed essentially or substantially of elemental aluminum, and a negatively-charged terminal or cell tab 30B, which in the same exemplary embodiment can be constructed essentially or substantially of elemental copper. The cell stabs 30A, 30B are electrode extensions that are internally welded to the various anodes and cathodes (not shown) comprising the battery cell 24, as will be understood by those of ordinary skill in the art.

Any number of battery cells 24 can be stacked or otherwise placed adjacently to each other to form a cell stack or battery module such as the battery module 50 of FIG. 3A. The substantial energy density and rechargeable capability of such a battery module, particularly those constructed using battery cells 24 constructed of a lithium ion polymer, allows a wide range of potential uses, including but not limited to an energy source for propulsion of an electric or a hybrid gas/electric vehicle.

Referring to FIG. 3A, a plurality of cell tabs 30A, 30B of the type shown with the battery cell 24 in FIG. 2 can be arranged or positioned adjacently to each other and to either side wall 20 of the interconnecting member 10, which is described in more detail above with reference to FIG. 1. In the embodiment of FIG. 3A, the cell tabs 30A, 30B are positioned to project outwardly from a slot or opening 19 formed in an upper surface or an interconnect board 18 of the battery module 50. Three cell tabs 30A, 30B are therefore positioned adjacent to each side wall 20 in the exemplary embodiment of FIG. 3A. However, those of ordinary skill in the art will understand that the actual number of cell tabs 30A, 30B for a given interconnecting member 10 can be expected to vary with the required voltage output of each battery module 50, as well as with the particular composition and output voltage of each battery cell 24 forming the battery module 50. Likewise, the number of interconnected battery modules 50 can vary to produce the required total output voltage for the system being powered.

As shown in FIG. 3A, the positively-charged cell tabs 30A of each of the battery cells 24 (see FIG. 2) are placed immediately adjacent to each other, as well as to one of the side walls 20 of the interconnecting member 10 (also see FIG. 1). The cell tabs 30A are then welded, fused, or otherwise joined with the side wall 20 to form a welded joint in an area generally denoted by the area or circle 22A. Likewise, the negatively-charged cell tabs 30B of each of the battery cells 24 (see FIG. 2) are placed immediately adjacent to each other, as well as to the other of the side walls 20 of the interconnecting member 10 (also see FIG. 1). The cell tabs 30B are then welded, fused, or otherwise joined with the side wall 20 to form another welded joint in an area generally denoted by the circle 22B. The orientation of the cell tabs 30A, 30B with respect to the interconnecting member 10 and the battery module 50 can also be seen in FIG. 5 as described below.

The formation of the welded joints can be accomplished using any welding or fusing means suitable for creating an electrically-conductive bond between each of the cell tabs 30A, 30B, and between the cells tabs 30A, 30B and the side walls 20 of the interconnecting member 10. In one embodiment, the welded joints of areas 22A and 22B are formed via an ultrasonic metal welding process, e.g., using a horn and anvil style welding apparatus. As will be understood by those of ordinary skill in the art, ultrasonic metal welding includes the controlled application of pressure and high-frequency mechanical vibration of approximately 20-40 kHz in order to form a solid, homogeneous bond or welded joint. Such a welded joint should be of sufficient quality to ensure electrical conduction between the various battery cells 24 through the interconnecting member 10.

As noted above, however, welded joints of any type can be subjected to shearing stresses, depending on the particular application. For example, when the battery module 50 of FIG. 3A and FIG. 5 is used to provide energy for propulsion of an electric or a hybrid gas/electric vehicle, the motion of the vehicle itself, as well as any motion of the battery module 50 in response thereto, can result in a shearing stress along the plane of the welded joints, or areas 22A, 22B of FIG. 3A. Such shearing stresses can potentially weaken or break the bond between the various cell tabs 30A, 30B and/or between the cell tabs 30A, 30B and the side walls 20 of the interlocking member 10. Likewise, chemical and/or electrolytic corrosion can weaken the welded joint over time, potentially affecting the voltage output of the battery module 50. To minimize the effects of such shearing stresses, the interconnect extensions 16 are folded, bent, or otherwise hemmed with respect to the cell tabs 30A, 30B, to thereby form a hem seam 32 as shown in phantom in FIG. 3A.

Referring to FIG. 3B, a perspective side view is provided of an interconnecting member 10 having a plurality of welded joints 22B and a plurality of cell tabs 30B. A set of cells tabs 30A are shown as they would appear prior to hemming of the interconnect extensions 16. The resultant hem seam 32 near the cell tabs 30B at least partially overlaps the welded or fused cell tabs 30B. In the exemplary embodiment of FIG. 3B, the hem seam 32 does so without also overlapping the welded joints 22B. However, those of ordinary skill in the art will recognize that the welded joints 22B themselves can be partially or fully overlapped by the hem seam 32 as shown in FIG. 3A depending on the size, shape, and/or length of the interconnect extensions 16.

In the embodiment of FIG. 3B there are three welded joints 22B and three hem seams 32, i.e., one interconnect extension 16 per welded joint 22B. However, a 1:1 ratio of hem seams 32 to interconnect extensions 16 is just one possible embodiment within the scope of the invention. Alternative embodiments can include a number of hem seams 32 and interconnect extensions 16 that exceed the number of welded joints 22, or a number of welded joints 22 that exceed the number of hem seams 32 and interconnect extensions 16, with the latter embodiment potentially including a single interconnect extension 16 that forms a continuous hem seam 32 for most or all of the length (L) of the interconnecting member 10, as shown in FIG. 1.

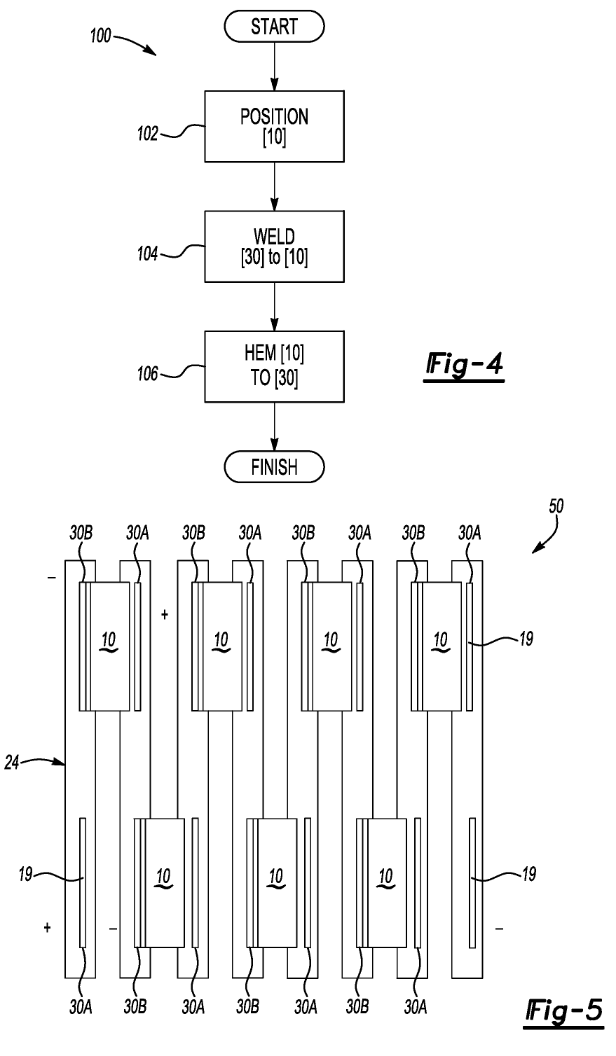

Accordingly, and with reference to FIG. 4 in conjunction with FIGS. 3A and 3B, a manufacturing process or method 100 is provided for forming the battery module 50 of FIG. 3, with the method 100 providing a means of reinforcing the welded joints 22, i.e., 22A or 22B depending on the cells tabs 30A, 30B being connected. At step 102, the required number of cell tabs 30, i.e., either of 30A or 30B, depending on which are being connected, are positioned immediately adjacent to each of the side walls 20 of the interconnecting member 10 such that the cell tabs 30A, 30B are held or otherwise retained in such a position in preparation for step 104. For example, a fixture or tool (not shown) can be used to clamp or retain the cell tabs 30A at the required position.

At step 104, each of the cell tabs 30A, 30B are welded or fused to each other and to a side wall 20 of the interconnecting member 10. Step 104 can be accomplished via any suitable welding or fusing method, provided the resultant welded joint is electrically conductive. For example, an ultrasonic metal welding process can be utilized as explained above to form a diffuse metallic bond of sufficient strength between the adjacent cell tabs 30A, 30B and side walls 20.

Upon completion of step 104, the resultant welded joints 22A, 22B should be sufficiently strong and/or durable. That is, absent execution of step 106 as described below the welded joints 22 should provide the battery module 50 with the desired functionality under normal or expected operating conditions. The addition of step 106 is therefore intended to further strengthen or optimize the integrity of the welded joints 22 beyond a level possible via welding or fusing alone.

At step 106, the interconnect extension 16 of the interconnecting member 10 is bent, folded, or otherwise hemmed to the cell tab 30 to thereby provide an additional level of security or support to the welded joints 22. In particular, and referring again to FIG. 3A, the plurality of interconnect extensions 16 (also see FIG. 1) of the interconnecting member 10 are bent, folded, or otherwise hemmed at least partially around or over the cell tabs 30 of the battery cells 24 to thereby form a hem seam 32 with respect to each of the welded joints 22. The hem seam 32 can at least partially overlap the welded joints 22 as shown in FIG. 3A, or not overlap the welded joints 22 at all as shown in FIG. 3B, depending on the intended design. In either case, the hem seam 32 provides added strength and support to the welded joints 22 in large part by reducing the effects of shearing stresses in proximity to the welded joints 22.

The resultant or final position of the hem seam 32 should prevent any movement of the individual cell tabs 30 in a radially-outward direction. Accordingly, a battery module 50 as exemplified in the various figures and formed via the method 100 of FIG. 4 can ensure that each of the cell tabs 30 remain in electrical connection with each other via the interconnecting member 10, while also minimizing effects of shearing stresses in the welded joints.

Referring to FIG. 5, the battery module 50 includes an interconnect board 18 defining a plurality of slots 19. One interconnecting member 10 straddles each adjacent pair of interconnect boards 18, with the cells tabs 30A, 30B of the battery cells 24 (see FIG. 2) extending or protruding through the slots 19. The cells tabs 30A, 30B are welded and hemmed to opposite sides the interconnecting members 10 as explained above, such that the positive (+) and negative (−) terminals or cell tabs 30Am 30B alternate within the battery module 50 as shown.

While the best modes for carrying out the invention have been described in detail, those familiar with the art to which this invention relates will recognize various alternative designs and embodiments for practicing the invention within the scope of the appended claims.

1. A battery module comprising:
an electrochemical battery cell having a positive and a negative cell tab; and
a pair of conductive interconnecting members each having an interconnect extension;
wherein the positive and negative cell tabs are welded to respective ones of the pair of conductive interconnecting members to thereby form a respective first and a second welded joint, and wherein the interconnect extension of each conductive interconnecting member is hemmed to thereby at least partially overlap the respective positive and the negative cell tab, and to thereby reinforce the respective first and second welded joint.

2. The battery module of claim 1, wherein at least one of the first and second welded joints is ultrasonically-welded.

3. The battery module of claim 1, wherein each of the conductive interconnecting members has a base and pair of side walls together defining a generally U-shaped profile, and wherein each of the first and second welded joint is formed with respect to a surface of one of the pair of side walls.

4. The battery module of claim 3, wherein each of the pair of side walls is formed integrally with the interconnect extension.

5. The battery module of claim 1, wherein the conductive interconnecting member is constructed substantially of copper.

6. The battery module of claim 1, wherein the positive cell tab is constructed substantially of aluminum, and wherein the negative cell tab is constructed substantially of copper.

7. A battery module comprising:
a plurality of electrochemical battery cells each having a positive cell tab and a negative cell tab; and
a plurality of elongated connecting members having a base and a pair of substantially parallel side walls defining a plurality of interconnect extensions, wherein each of the elongated connecting members is constructed essentially of a conductive material;
wherein each of the respective positive and negative cell tabs are ultrasonically welded together and to a respective one of the parallel side walls to thereby form a pair of welded joints, and wherein each of the interconnect extensions are hemmed with respect to one of the positive and negative cell tabs in an overlapping manner, thereby reinforcing the pair of welded joints and minimizing the effects of shearing stress in the welded joints.

8. The battery module of claim 7, wherein the elongated connecting member has a generally U-shaped profile.

9. The battery module of claim 8, wherein at least one of the interconnect extensions is substantially rectangular in shape.

10. The battery module of claim 7, wherein the elongated connecting member is constructed substantially of copper.

11. The battery module of claim 7, wherein each of the plurality of electrochemical battery cells is configured as a lithium polymer ion cell.

12. A method of minimizing effects of a shearing stress in a battery module comprising:
fusing a positive cell tab of a battery cell to a surface of a first elongated connecting member to thereby form a first welded joint;
fusing a negative cell tab of the battery cell to a surface of a second elongated connecting member to thereby form a second welded joint; and
hemming a portion of the first and second elongated connecting members to a respective one of the first and second welded joint to thereby form a pair of hem seams;
wherein the hem seams each at least partially overlap the respective positive and negative cell tabs, thereby minimizing the effects of the shearing stress in the first and second welded joints.

13. The method of claim 12, wherein each of the first and the second elongated members has a pair of side walls each defining at least a pair of interconnect extensions, and wherein hemming a portion of the first and the second elongated connecting members includes hemming each of the pair of interconnect extensions.

14. The method of claim 13, wherein fusing the positive and negative cell tabs includes ultrasonically welding the positive and negative cell tabs to one of the pair of side walls of different ones of the first and second elongated connecting members.
